(19) United States
(12) Patent Application Publication
(10) Pub. No.: US 2003/0125998 A1
(43) Pub. Date: Jul. 3, 2003

(54) Method for managing resource assets for emergency situations

(75) Inventors: Scott A. McKenney, Oak Ridge, TN (US); Robert D. Hunter, Knoxville, TN (US)

Correspondence Address: Robert M Poteat P C, P O Box 4698, Oak Ridge, TN, 37830, US

(73) Assignee: MHG, LLC, Oak Ridge, TN

(21) Appl. No.: 10/038,572

(22) Filed: Jan. 3, 2002

(51) Int. Cl. G06F 17/60

(52) U.S. Cl. 705/7

(57) ABSTRACT

A method for collecting, organizing, presenting, and using data relative to the scene of an emergency situation is disclosed. The method uses a Responder Assets Management System (RAMS) composed of four modules including information, logistics, operations, and planning. The information module makes general information immediately available to responders. The logistics module assists in managing equipment resources during a contingency and includes an equipment manager interface for managing equipment used to respond to an emergency situation. The operations module supports daily operations responsibilities and scales to handle significant emergencies and includes at least one of a situational awareness interface, a response options generator (ROG) interface, an operations manager interface, a messenger interface and a status board interface. The situational awareness interface is designed for emergency and crisis response managers to provide enhanced, community-wide situational awareness using full immersion, spherical images, Geographic Information System (GIS) maps, site and floor plans, and a database interface to provide virtual walk-through, pre-incident plans, for contingency planning, training visualization, and operational support. The ROG interface provides automated response and resource estimates to decision-makers in command posts and on-site in developing a response to significant, unplanned events. The operations manager interface is used by a remote headquarters to monitor an on-going operation. The messenger interface is a pre-formatted, topic oriented messaging system that supports both informational messages and messages that automatically update system data and displays. The status board interface is a situation display of key situational awareness data. The planning module assists users in planning for critical events.

### STATEMENT REGARDING FEDERALLY SPONSORED RESEARCH OR DEVELOPMENT

This invention was made with Government support under Work for Others Project No. 2247-1103-Y1 under Prime contract No. DE-AC05-84OR21400 with Lockheed Martin Energy Systems, Inc. (now BWXT Y-12) and Prime Contract No. DE-AC-05-96OR22464 with Lockheed Martin Energy Research Corporation (now UT-Battelle LLC). The Government has certain rights in the invention.

### CROSS REFERENCE TO RELATED APPLICATIONS

Not Applicable

### BACKGROUND OF THE INVENTION

1. Field of Invention

This invention pertains to a method for managing resource assets for emergency situations. More particularly, this invention pertains to a method for managing resource assets through the use of software and computer systems.

2. Description of the Related Art

Today, communities are faced with a monumental task of ensuring that they are adequately prepared for major events, including terrorist attacks with biological weapons of mass destruction. These communities also must prepare for similar threats to major planned events such as the Super Bowl. A key requirement for public safety agencies responding to these events is “situational awareness”. With respect to situational awareness, it is well known that the emergency responder community has been attempting to develop a practical method of developing and maintaining a virtual walk-through of a facility. By providing such information, along with a method for using the same, the potential for saving lives and property is enhanced. Efforts to date have approached the problem by creating at best a three dimensional line drawing of the facility. However, due to computer processor speed limitations, this was not a practical approach until recently. As the processor speeds have increased to a sufficient speed, the issue remains that producing enough drawings to fully illustrate a number of buildings is cost prohibitive.

One method used today is FloorView provided by FloorView, LLC, Ft. Lauderdale, Fla. FloorView is provided for emergency response teams to quickly access critical information for schools, day care centers, hospitals, hotels, and other public buildings for effectively dealing with emergency situations including natural disasters or illegal activity. FloorView incorporates an Internet browser with digital drafting software and digital maps. The data is available via the Internet using a secure connection. However, because the data is only available via the Internet, the emergency response team must have Internet access at the scene of the emergency. This can pose a problem where the response team is situated in a temporary location and access must be established via wireless connection. In many situations, the use of mobile phones is severely restricted if available at all. Further, such access renders contemporaneous updates difficult at best.

Further, the data available through FloorView is not map-based. Specifically, the maps utilized in the FloorView method cannot be expanded in order to view closer images of portions of a map.

While there are several prior art techniques for providing “situational awareness”, there are no known prior art techniques that exist for providing an automated response to major terrorists incidents involving biological attacks.

There is therefore a need to provide a highly integrated method for managing resource assets for emergency events, including major biological attacks, that permits decision-makers in handling such events to make rapid and accurate decisions.

### BRIEF SUMMARY OF THE INVENTION

According to one embodiment of the present invention a method for collecting, organizing, presenting and using data relative to the scene of an emergency situation is disclosed. The method of the present invention is performed using a Responder Assets Management System (RAMS) composed of four modules including information, logistics, operations, and planning. Central to RAMS is the functionality during emergency situations. RAMS utilizes two key functions with several supporting functions. The first key function of RAMS is the organization and presentation of key decision information in localized, spatial formats so that the decision maker has all the information needed and only the information needed to respond to a crisis situation.

The second key function of RAMS is the automatic assistance in the development of a course of action for a disaster or crisis situation, and production of a time-phased list of personnel and supply resources required to support the course of action. The time-phased resource list allows the decision-maker for the first time to be pro-active rather than reactive during a crisis situation. All of the other functions of this method work together to support these two key functions and contribute to a decision-maker's ability to make more rapid, accurate decisions.

Advantageously, the method of the invention provides an interface that is easy to use, with common interface concepts used across the system. The RAMS interface requires minimal windows to be open at any one time, reducing the possibility of the user becoming lost or confused during a crisis situation. Menus are also minimal, with frequently used functions having a button always visible on the screen.

The information module makes general information immediately available to responders. The information module includes links to various information sources, including at least, local weather and national weather, and links to general information. The local weather link provides local weather information on the web, and is used primarily by sites without access to a weather provider service. Similarly, the national weather link provides national weather information on the web. The information tree provides rapid access to standard operating procedures, maps, pictures and information categorized and populated by the user. It supports multiple paths to the same document, so the user may cross-categorize information for rapid retrieval. The information module supports the needs of decision-makers during a crisis or planned major event by making critical general information immediately available within the RAMS interface.

The logistics module assists the responder in managing equipment resources during a contingency. The logistics module includes an equipment manager interface for managing equipment used to respond to an emergency situation. The equipment manager interface tracks equipment owned by the organization(s) involved in responding to the emergency, equipment borrowed or leased from another organization, and equipment that is loaned to other organizations to help with an emergency situation. The equipment manager interface interacts with the operations module to link equipment to a specific operation underway. As equipment is assigned to an operation, the date and time of the assignment are automatically recorded. The same information is captured when equipment is returned from the operation. So, when a city is inundated with support from outside agencies, as is common in a major planned event or disaster, the logistics module provides emergency managers with a tool to track and manage these resources.

The operations module supports daily operations responsibilities and scales to handle significant emergencies. The operations module incorporates several interfaces including at least one of a situational awareness interface, a response options generator (ROG) interface, an operations manager interface, a messenger interface and a status board interface.

The situational awareness interface is designed for emergency and crisis response managers to provide enhanced, community-wide situational awareness. The situational awareness interface uses full immersion, spherical image technologies, such as those produced by Internet Pictures Corporation [iPIX), Geographic Information System (GIS) maps, site and floor plans, and a database interface. Together, these provide a virtual walk-through capability of a building or facility, localized information such as pre-incident plans, and support for contingency planning, training visualization, and operational response management. The database includes information such as photographs, inventories, emergency plans, checklists and other documents that are associated with specific locations in a building and/or facility. For on-scene commanders, tools are available to add annotations describing the extent of damage, locations of equipment and personnel, and other incident-specific information. As this incident-specific information is added to the database, it is date/time stamped to provide an accurate record of the response actions taken. The situational awareness interface at the scene of an incident is also used to provide this incident-specific information to the operations manager interface in the command center, making the dynamic data collected about an incident such as on-scene photos of the incident, and locations of responders, equipment, and casualties available to other emergency managers.

The situational awareness interface provides quick access to information about the scene of the contingency and visual situational awareness. Using a localized information paradigm, icons linking information about a location are placed on a floor plan or map at the location where the information is needed. Duplicate and supplementary information is stored on a hierarchical catalog, displayed as the standard file explorer tree used throughout the operating system. This ensures that the decision-maker has the information needed quickly and efficiently, without having to sift through unneeded information first.

The situational awareness interface provides a plurality of visual cues to ensure quick identification of key items on the map or floor plan displays. Each symbol is capable of including custom text to provide specifics about the item. Custom symbols are available for identifying the location of fire and police equipment. Floor plans are annotated and color-coded. The situational awareness interface thus provides a virtual walk-through of a building, facility, or site. On such a walk-through, the visual images provide visual context to the situation. Where visibility in a room or a building is low (e.g., smoke from a fire), stored images inform personnel what to expect in that area, including size, location of exits, contents, and the like.

Prior to RAMS, no tool organized situational awareness information in such a way as to provide a realistic method of making a virtual walk-through of a facility available to emergency responders, while at the same time making information critical to the response available in the same interface, through multiple means, linked to both spatial diagrams and hierarchical categories.

A response options generator (ROG) interface provides automated response and resource estimates to decision-makers in command posts and on-site in developing a response to significant, unplanned events. The ROG interface also supports automated checklists to be shared electronically, enabling command centers to track progress at the site. For major situations, the ROG interface supports automated response planning, including estimation of resources required and tasks to complete, time-phased over the projected duration of the event.

The ROG interface is also used to automatically access the RAMS schedules and personnel and equipment databases to determine what resources are available to meet the requirements expressed in the time-phased resource list. The RAMS databases manage the status of the shortfalls, automatically requesting resources from neighboring principalities and/or local, state and federal government entities.

The operations manager interface is used by a remote headquarters to monitor an on-going operation. Similar to the situational awareness interface, the operations manager interface provides additional functions to manage the information about an operation. The operations manager interface provides a means to create a record for an operation, the record including information such as where the event occurred, when the event occurred, what the event was, and the like. In addition, the operations manager interface provides a means to view and manage the information provided by the situational awareness interface used at the scene of multiple incidents in a single interface. Thus, this is a key RAMS functionality for higher-level emergency managers to track and manage emergency situations.

The messenger interface is a pre-formatted, topic oriented messaging system that supports both informational messages and messages that automatically update system data and displays. The messenger interface integrates with the operations manager interface for ongoing operations and supports message types that update data in other parts of the system. A key function of the messenger interface is to provide a means for supporting agencies to update RAMS databases on the status of their personnel and supply resources they are making available to support the emergency situation.

The status board interface is a user configurable, menu driven situation display of key situational awareness data. The status board interface automatically updates as information is changed in the system. Status information from a plurality of information areas is monitored via the status board interface.

The planning module assists users in planning for critical events, including unplanned terrorist or disasters and planned major events. Included are a ROG creator, a situational awareness interface creator, a traffic manager, and an information tree creator. The ROG creator provides the user the ability to customize the underlying ROG checklists and automated response sub-modules for a specific city or organization. The ROG creator also provides the ability to create new checklists and modify response templates. The situational awareness interface creator allows the user to create base data for the situational awareness interface. The traffic manager interface is used to develop traffic management plans as input by the user. The information tree creator is used to design information categories and input documents to be viewed by the information tree. Together, these form a powerful planning capability not currently available to emergency managers and managers of major special events. As such, it both supports and encourages greater detail in planning than has been practical or useful in the past.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a schematic diagram of the method of the present invention;

FIG. 2 is a schematic illustration of the information tree of the present invention;

FIG. 3 is a schematic illustration of a national weather map link accessed through the information module of the present invention;

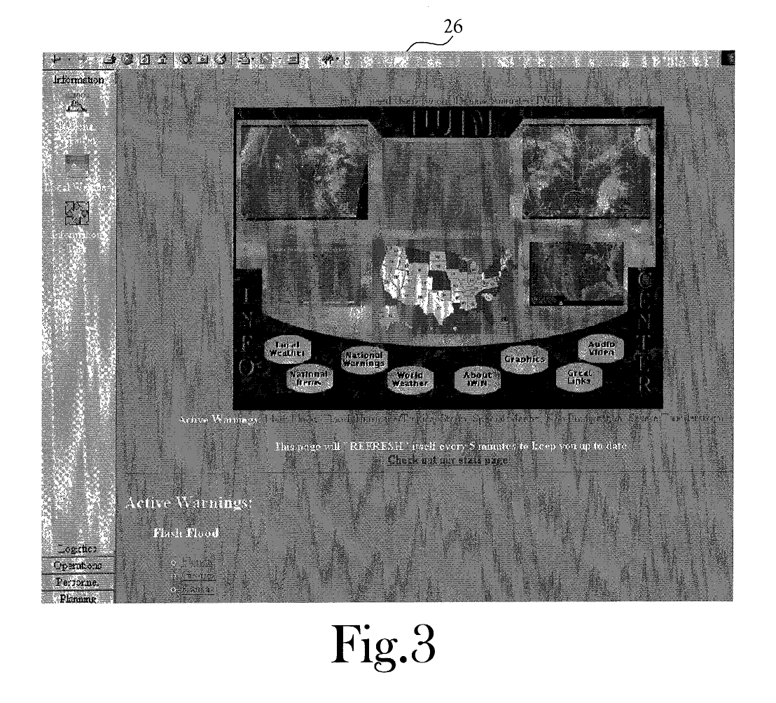

FIG. 4 is a schematic illustration of a full immersion, spherical image, e.g., 360° photograph used in the situational awareness interface of the operations module of the present invention;

FIG. 5 is a schematic illustration of a geographic map used in the situational awareness interface of the operations module of the present invention;

FIG. 6 is a schematic illustration of a floor plan used in the situational awareness interface of the operations module of the present invention;

FIG. 7 is a schematic illustration of a checklist used by the response options generator interface of the operations module of the present invention;

FIG. 8 is a schematic illustration of a time-phased resources list generated by the response operations generator interface of the operations module of the present invention;

FIG. 9 is a schematic illustration of a total human impact profile generated by the response operations generator interface of the operations module of the present invention;

FIG. 10 is a schematic illustration of a base template used by the response operations generator interface of the operations module of the present invention;

FIG. 11 is a schematic illustration of an agent fact sheet used by the response operations generator interface of the operations module of the present invention;

FIG. 12 is a schematic illustration of the messenger interface of the operations module of the present invention; and

FIG. 13 is a schematic illustration of the status board interface of the operations module of the present invention.

### DESCRIPTION OF THE INVENTION

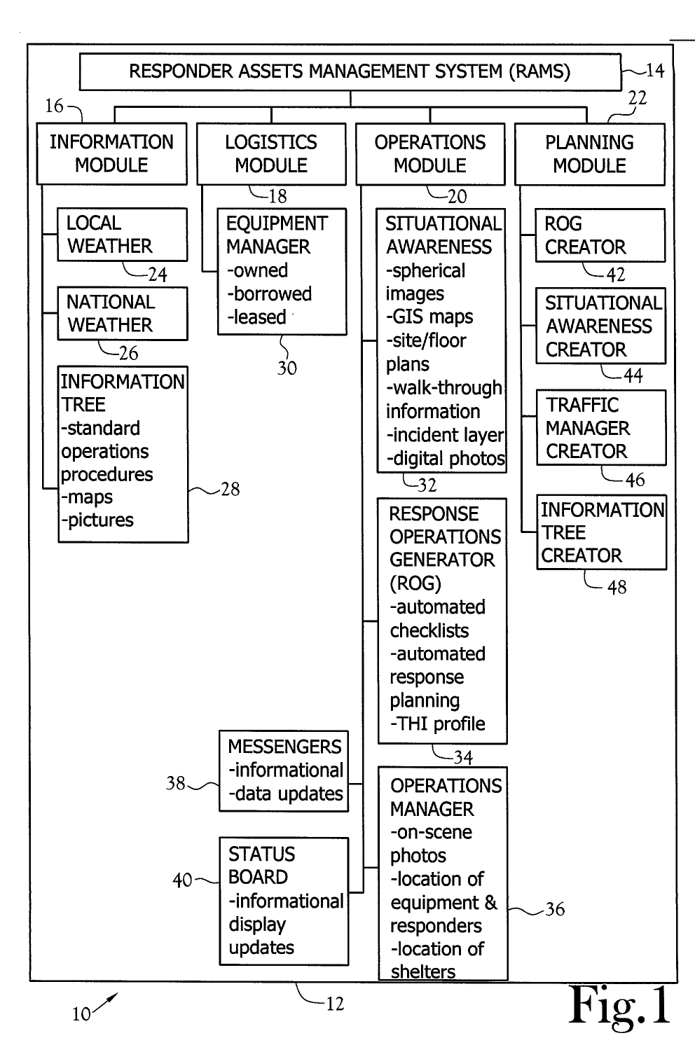

The method of the present invention is illustrated schematically in FIG. 1. The method, illustrated at 10 is performed using a computer 12 having memory in which is stored a Responder Assets Management System (RAMS) 14 composed of four modules. In addition, by providing a portable computer with the situational awareness interface and associated data to be described below, an emergency response team at the scene of an incident is able to have immediate access to information relevant to the facility at which the emergency has occurred. Further, the emergency response team is capable of updating information regarding the facility as the response continues.

The four RAMS 14 modules include, in the illustrated embodiment, information 16, logistics 18, operations 20, and planning 22. Each module includes at least one function, some functions operating independently of each other function. However, many of the functions are interdependent to provide enhanced functionality. All the functions are accessible from a single, integrated interface. The interface may be operated from a conventional web browser in which all operational information is displayed.

Central to RAMS 14 is the functionality during crisis and emergency situations. As such, the interface is easy to use, with common interface concepts used across the system. The RAMS 14 interface requires minimal windows to be open at any one time, reducing the possibility of the user becoming lost or confused during a crisis situation. Menus are also minimal, with frequently used functions having a button always visible on the screen. Thus a user is not confused by functions otherwise hidden in menus.

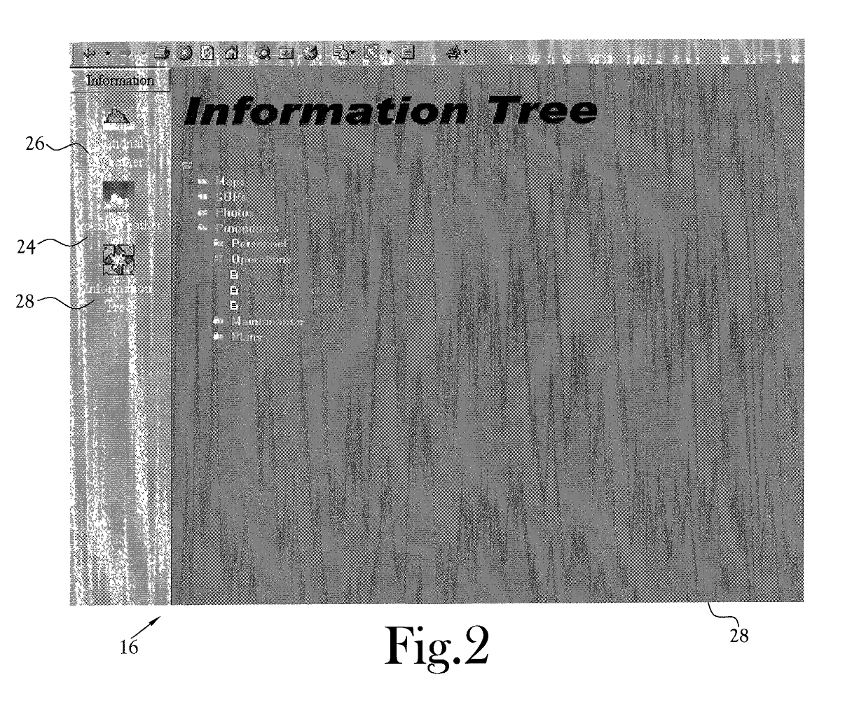

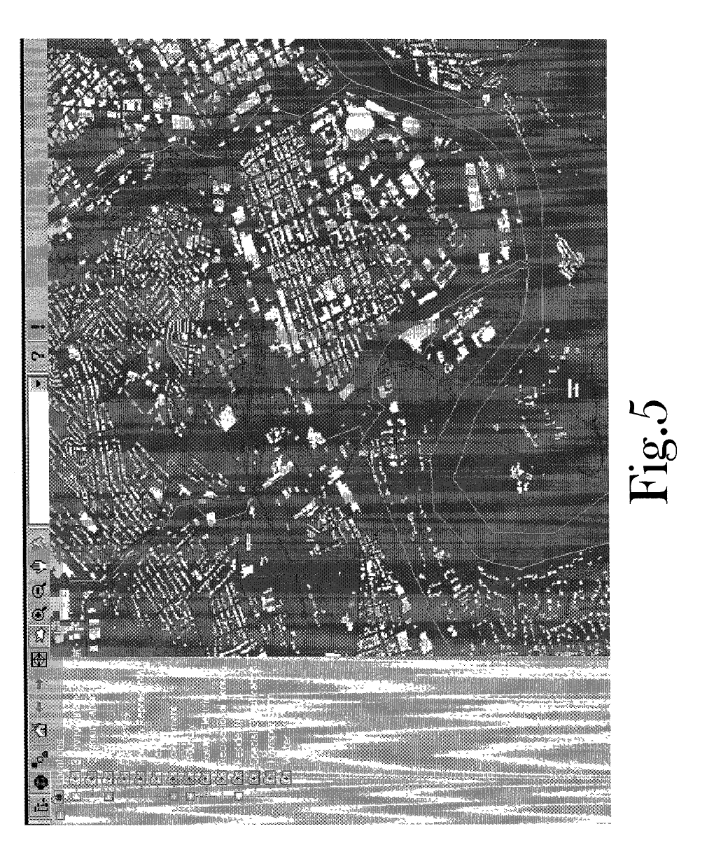

The information module 16, as illustrated in FIG. 2, makes general information immediately available to responders. The information module 16 includes links to various information sources, including at least, local weather and national weather, and information about the particular disaster site. The local weather link 24 provides local weather information on the web, for use by sites without access to a commercial weather provider service. Similarly, the national weather link 26 provides national weather information on the web, as illustrated in FIG. 5.

The information tree 28 provides rapid access to standard operating procedures, maps, pictures and information categorized and populated by the user. It supports multiple paths to the same document, so the user may cross-categorize information for rapid retrieval. The information tree creator 48 is used to organize and load the data used in the information tree 28.

The information tree interface 28 includes user defined categories and subcategories leading to the various documents. This ensures that the information can be organized in a way suitable to the agency using the information tree. A document in the information tree 28 is accessed in a conventional manner such as by selecting the document in the information tree 28 with an input device such a computer mouse in order to open the document in the web browser window, if appropriate, or in a separate commercially-available viewer application.

The logistics module 18 assists the responder in managing equipment resources during a contingency. The logistics module 18 includes an equipment manager interface 30 for managing equipment used to respond to an emergency situation. The equipment manager interface 30 tracks equipment owned by the organization(s) involved in responding to the emergency, equipment borrowed or leased from another organization, and equipment that is loaned to other organizations to help with an emergency situation. In addition, the equipment manager interface 30 carries detailed ownership and status information about the equipment.

The equipment manager interface 30 interacts with the operations module 20, described below, to link equipment to a specific operation underway. As equipment is assigned to an operation, the date and time of the assignment are automatically recorded. The same information is captured when equipment is returned from the operation. This facilitates the production of a Federal Emergency Management Agency (FEMA) Report, which is required when an organization participates in a FEMA-reimbursable contingency. The FEMA Report is a detailed report showing each piece of equipment used in the contingency and how long it was used in order to determine any amount of reimbursement.

The equipment manager interface 30 incorporates a tree showing the various categories of information. The user scrolls down to the piece of equipment of interest and is able to see detailed data on the specific equipment. These functions make possible the tracking of all equipment resources used during a major event or disaster, solving a critical management problem faced by emergency managers when numerous outside agencies donate or loan equipment to a city for the incident.

The operations module 20 supports daily operations responsibilities and scales to handle significant emergencies. The operations module 20 incorporates several interfaces including at least one 40 of a situational awareness interface 32, a response options generator (ROG) 34, an operations manager interface 36, a messenger interface 38 and a status board interface 40. Other interfaces may be incorporated as well, as dependent on the particular emergency situation.

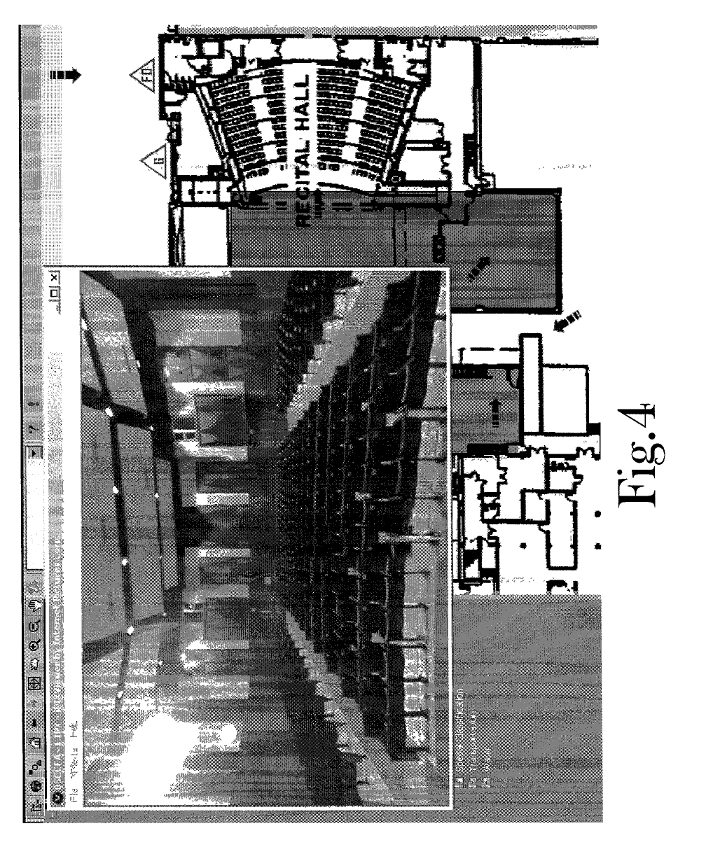

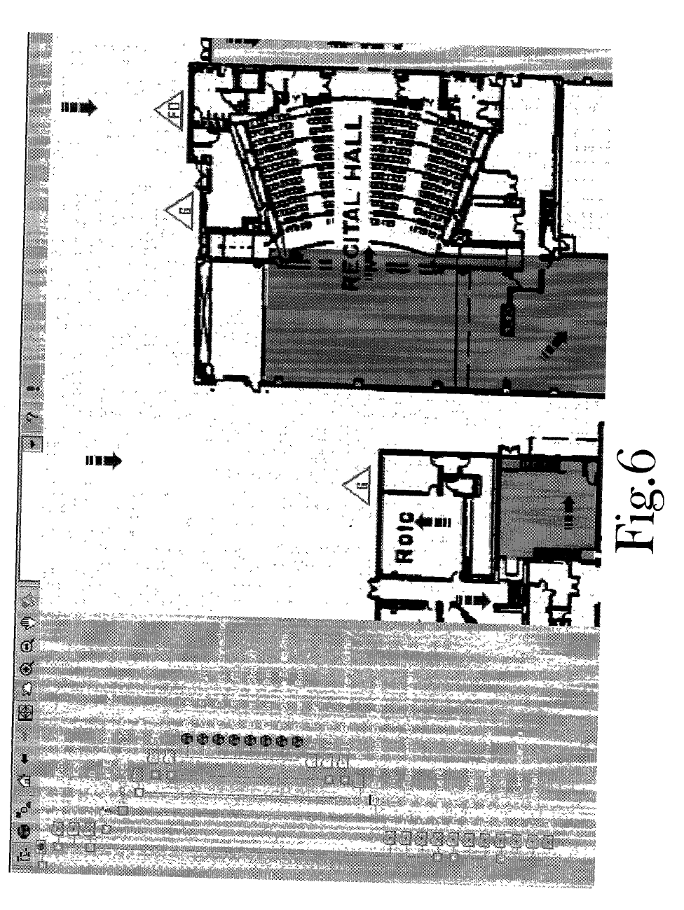

The situational awareness interface 32 is designed for emergency and crisis response managers to provide enhanced, community-wide situational awareness. The situational awareness interface 32 uses, for example, full immersion, spherical images (FIG. 4) produced by Internet Pictures Corporation [iPIX), Geographic Information System (GIS) maps (see FIG. 5), site and floor plans (see FIG. 6), and a database interface to provide virtual walk-through, pre-incident plans, for contingency planning, training visualization, and operational support. A database is implemented by the situational awareness interface 32, the database including information such as photographs, inventories, emergency plans, checklists and other documents are associated with specific locations in a building and/or facility. Annotations describing the extent of damage, locations of equipment and personnel, and other incident-specific information can be added to the database by the on-scene commander and transmitted back for review by decision-makers at command centers. This interface provides a multiplicity of redundant methods for on-scene commanders to add this information. This ensures that the on-scene commander can use whatever method is familiar.

The situational awareness interface 32 assists incident command and various responder team commanders in potential life-threatening situations. For example, inspections of vacant buildings and pre-fire planning assist firefighters and other rescue workers in navigating through buildings when there is little visibility due to smoke or darkness. On Dec. 3, 1999, six firefighters died during a warehouse fire in Worcester, Mass. The present invention using the situational awareness pre-incident plan coupled with radio communication would have enabled the Worcester incident commander to guide the lost and confused firefighters out of the maze-like, six-floor building. Likewise, tactical entry by SWAT teams at the April, 1999 Columbine High School massacre was delayed by over 45 minutes because incident command did not have school floor plans and could not provide adequate situational awareness to SWAT team commanders. The situational awareness interface 32 of the present invention provides such information that could have assisted Columbine incident command with enhanced situational awareness.

The situational awareness interface 32 provides dual approaches to the use of data. First, a user can navigate a tree to the desired data. For example, a user in one particular situation selects a building, then a list of critical items for a particular floor, then the location of the main power shut-off switch. Second, the GIS map is used to zoom to the building, drill into it to see the floor plan, and then identify the shut-off switch. The situational awareness interface 32 employs a map display that is faster than any other similar capability on the market, while maintaining compatibility with the leading map formats, which is important for a tool used on-scene in an emergency situation as it is critical for the time to be minimized for redrawing a map while responding to a crisis.

The situational awareness interface 32 provides solutions to at least two key issues that have long plagued the emergency responder community, those being quick access to information about the scene of the contingency, and visual situational awareness. Because the situational awareness interface is designed specifically for on-scene emergency response, the manner in which a user accesses the information in the system is critical as any time wasted looking for the information may result in a loss of property or loss of life. Therefore, in order to ensure rapid and intuitive access of critical information, the situational awareness interface incorporates a highly visual localized information paradigm, coupled with a redundant hierarchical catalog.

Using the localized information paradigm, icons linking information about a location are placed on a floor plan or map at the location where the information is needed. For example, if a classroom is used to store chemicals, an icon that indicates a chemical hazard is placed on the classroom floor plan where the chemicals are stored. Clicking on the icon opens a list of the chemicals in this area of the classroom.

Duplicate and supplementary information is also stored on the hierarchical catalog, displayed as the standard file explorer tree used throughout the operating system. Using the process of storing information close to where needed, primary and supplementary information is cataloged under the floor of the building. For example, MSDS sheets (standard chemical safety information used by responders) are stored in a folder labeled “MSDS” under the folder for the floor that contains the chemistry classroom.

In addition to providing dual methods to rapidly locate information, the situational awareness interface 32 provides a plurality of visual cues to ensure quick identification of key items on the map or floor plan displays. For example, selected items are made to flash on the map or floor plan for rapid location. Further, standard National Fire Protection Association symbols are used on the floor plans to identify fire exits, chemical hazards, and the like. Each symbol is capable of including custom text to provide specifics about the item. Custom symbols are available for identifying the location of fire and police equipment. Also, floor plans are annotated and color-coded.

Thus, the situational awareness interface 42 is able to successfully provide a virtual walk-through of a building, facility, or site. The unique combination of full immersion images linked to maps and floor plans, along with key information in the form of symbols or links, provides a practical virtual walk-through capability for first responders. On such a walk-through, the visual images provide visual context to the situation. Where visibility in a room or a building is low, stored images inform personnel what to expect in that area, including size, location of exits, contents, and the like.

The situational awareness interface 32 further includes an incident layer, which is a layer of information reserved to capture information specific to a particular incident. Such information includes digital photos of damage such as, for example, damage of a building due to the detonation of a bomb. Such pictures also include pictures showing the location of the triage area, the press area, guards, or other areas of interest. This data is used to track the operational response to an incident, and is viewed in the context of the static data previously collected about the facility prior to the incident. As incident-specific information is added to the interface, it is date/time stamped to provide an accurate record of the response to the incident.

During the incident, the information on the incident layer is capable of being transmitted to a remote site for use with the operations manager interface, which provides a better understanding of the situation in order to obtain the necessary resources to support the on-scene forces. Once the incident is complete, the incident data is archived and the system is prepared for a new incident at that facility.

In a major contingency such as a natural disaster or an act of terrorism such as a bombing, an agency headquarters command center and/or a local principality emergency command center is activated. The situational awareness interface communicates with the RAMS operations manager 36 interface to provide headquarters situation awareness and decision information. The situational awareness interface 32 provides orientation to the area of the incident. The map display identifies the road topology in the area of the incident, providing immediate information on what will be needed to limit access to the area. The area plan of the building where the incident is taking place provides orientation as to where key facilities are located, such as the power and gas shut-offs, potential staging area, triage areas, and the like. Evacuation routes for the building are reviewed as well. Prior to arriving at the scene, therefore, those having responsibility to manage the response are better prepared.

Upon arriving at the scene of an event, the situational awareness interface 32 records any decisions made regarding placement of resources and personnel. Digital photos of any damage are also entered through the situational awareness interface 32. At the conclusion of the incident, any data input is archived for future review and may be added to the operations manager 36 database for display or future retrieval.

During the incident, the situational awareness interface 32 provides situational awareness information described above needed for responders to take action more quickly and safely. The incident layer provides an intelligent surface to plan and execute the response, providing feedback as desired.

For a more isolated incident such as a normal house fire, the procedure for response using the situational awareness interface 32 is similar to the process for a major incident, except that the responder will not need to transmit the incident layer data to a remote location such as an event headquarters.

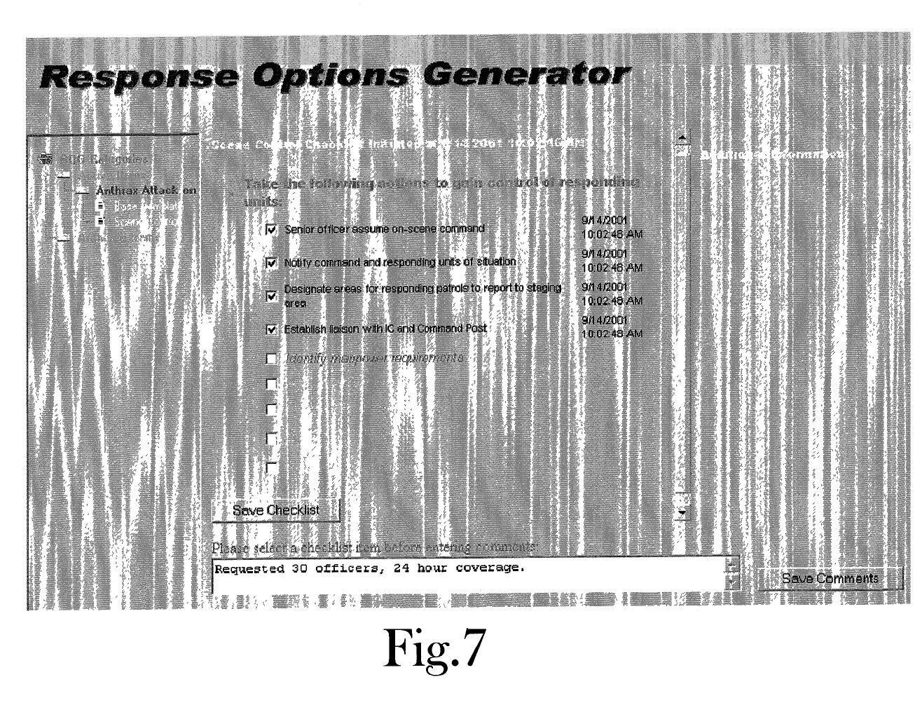

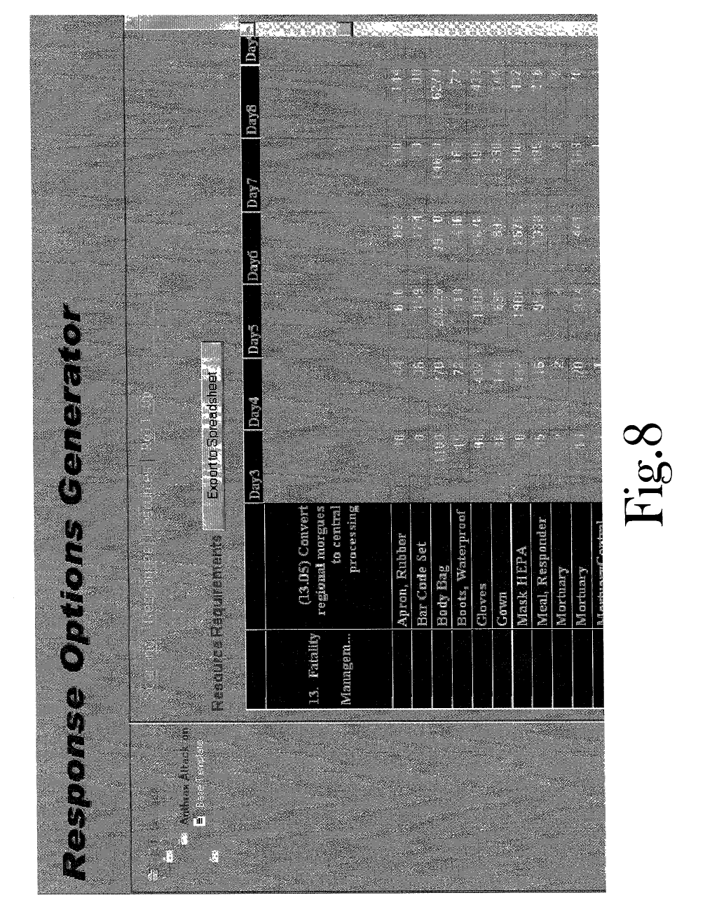

A response options generator (ROG) interface 34 provides automated response and resource estimates to decision-makers in command posts and on-site in developing a response to significant, unplanned events. The ROG interface 34 also supports automated checklists, as illustrated in FIG. 7, to be shared electronically, enabling command centers to track progress at the site. For major terrorist actions or natural disasters, the ROG interface 34 supports automated response planning, including estimation of resources required and tasks to complete, time-phased over the projected duration of the event, as illustrated in FIG. 8.

The ROG interface 34 provides a single interface for determining an appropriate response for a particular incident. For simple incidents, the ROG interface 34 provides electronic checklists including a step-by-step description of actions to be taken. For more complex incidents such as natural disasters and biological or chemical terrorism, the ROG interface 34 guides the user through the issues that need to be considered, both immediate and future. The ROG interface 34 then produces a time-phased resource requirements list along with tools to determine local resource gaps. The time-phased list provides a projection of needs calibrated to the extent of the incident.

Based on the options selected, the ROG interface 34 generates a time-phased list of resources that are needed to support the options. The resource list identifies how many personnel, by skill area, and supplies are required on each day to respond to the contingency. This projection is done over the anticipated life of the contingency. The ROG interface 34 provides a means to compare these requirements with existing resources to project shortfalls. This allows the decision-maker to know well in advance what type of resources will need to be requested from other principalities and/or government entities. This information is formatted as a request and either made available on a password controlled website or as a RAMS 14 messenger request to other principalities and/or government entities that use RAMS 14. As situations change or more information becomes available on the contingency, the ROG interface input parameters are updated and the resource forecasts revised.

The ROG interface 34 integrates with the operations manager 36 interface to associate a response to a specific operation underway. The ROG interface 34 operates entirely within a web browser. Interface elements are kept simple and obvious to minimize confusion during an emergency situation. Information is entered and revised throughout the incident as better information becomes available.

The ROG interface 34 is useful either as an integrated tool of RAMS 12 or as a stand-alone tool. As a stand-alone tool, the ROG interface 34 does not support integration with the operations manager interface 36 or the RAMS 14 personnel and equipment systems and the resultant ability to automatically determine shortfalls. The ROG interface 34 can also be made accessible via the Internet.

The ROG interface 34 in one embodiment is provided for use during the response to a particular contingency. In a further embodiment, the ROG interface 34 is designed to allow customization of the ROG interface 34 options and calculations to the specific community through use of the ROG creator interface 42.

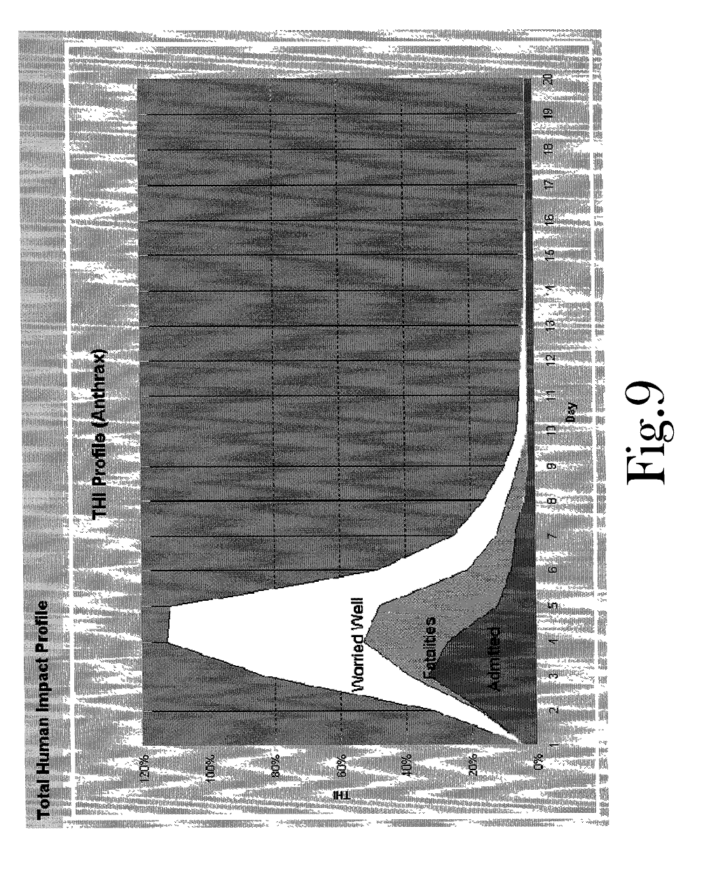

In forecasting resources required for a particular contingency, the ROG interface 34 relies on a number of different characterizations of the event. Included in such factors is the total human impact (THI), illustrated in FIG. 9, which is a profile over time of the number of people that are likely to be affected by the event. While responders are needed to provide physical security of buildings, etc., the largest impact on responder requirements is usually taking care of the sick, wounded, displaced, or otherwise impacted people. The THI profiles provide the baseline for impacted people. This baseline is used for developing equations that adequately forecast the responder requirements.

Several profiles are developed by the ROG interface 34, which further assists the user in understanding and visualizing the impact of a biological terrorist incident on the medical system of a community. For in the case of a biological attack, the THI is primarily driven by the agent that was used. Illustrated in FIG. 9 is an example of a THI for an Anthrax attack. This graph profiles how an Anthrax attack would play out over a 21-day period. Illustrated are percentages of all people affected by the biological event who will be admitted to a hospital, who will become fatalities, and who will complain of symptoms of the disease but who are not infected. The latter category is labeled “worried well”. The illustration indicates that few people will show signs of infection the first day or so. By day 4 the profile shows that 35% of the total workload for public safety and medical responders will be in the hospital, another few percent will become fatalities that day (peaking out on day 5), and that a large percentage will be the worried well. However, the disease will take its course and workloads will dramatically drop off by day 8. In this scenario, it is important to account for the worried well since there will be a need for medical personnel to confirm their non-infection.

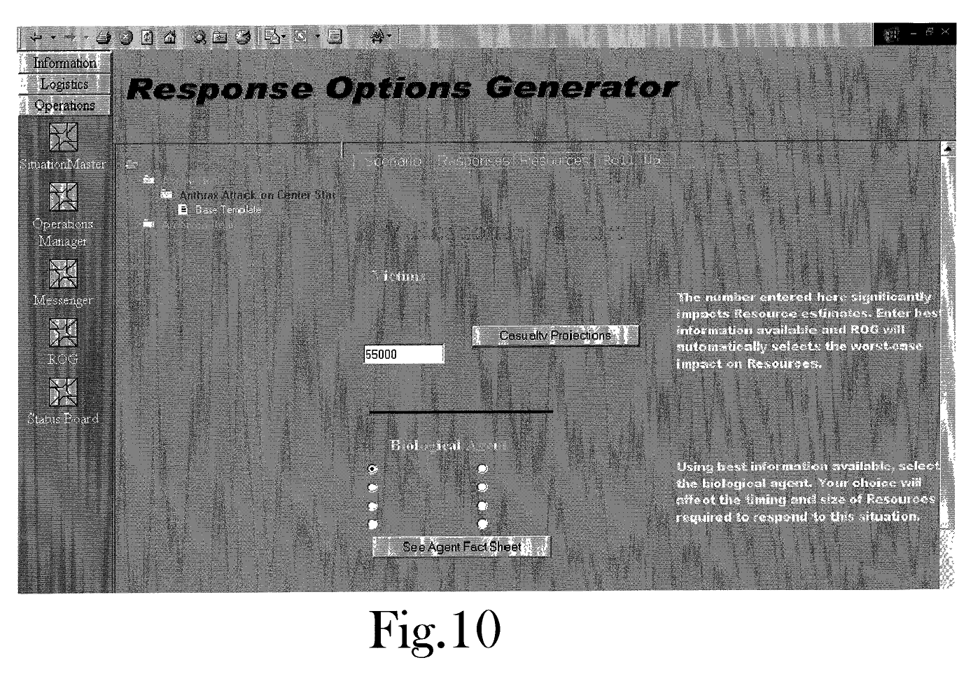

In order to determine the required resources for a particular contingency, the ROG interface 34 first determines the scope of the contingency. For major contingencies, the ROG interface 34 is used to identify key areas of concerns with appropriate options. The ROG interface 34 first characterizes the situation, as illustrated in FIG. 10. The first level of characterization is identifying what type of contingency is underway. The user has a supported contingencies tree where the appropriate contingency is selected. The user is next presented with a characterization page specific to the selected contingency. This page is used to collect information useful in characterizing the selected contingency. For example, in the case of a biological attack, the potential number of people exposed is a key characterization, as is the number of hospital beds available in the city.

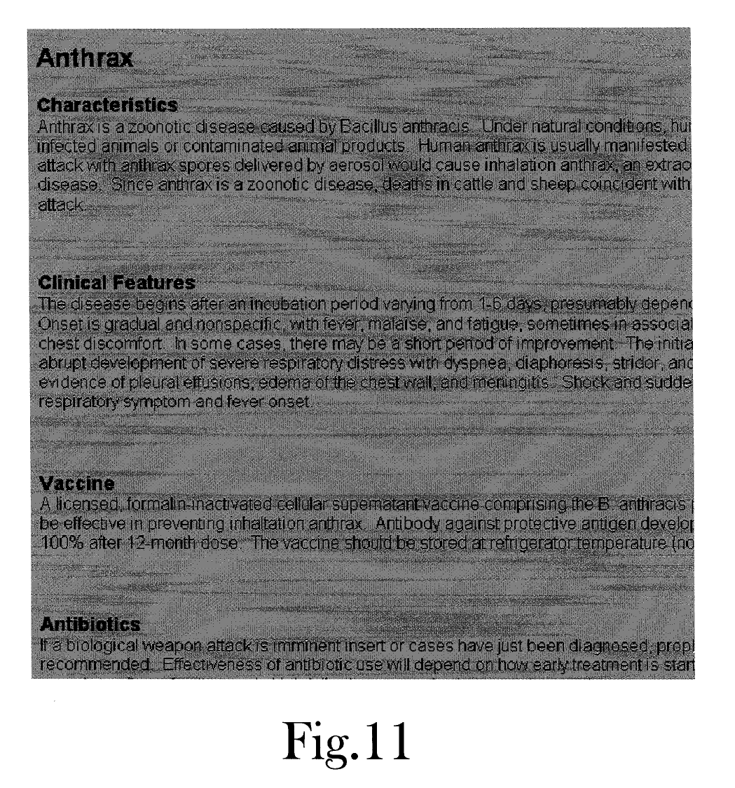

Once the characterization information is supplied, the background information appropriate to the situation is viewed. In the example of a biological attack, if the user determines the agent used was Anthrax, the user reviews the THI for Anthrax to get an understanding of how and when it will impact the city. Next, the user reviews a fact sheet for Anthrax, illustrated in FIG. 11, describing the symptoms, treatments, etc. Finally, a graph is displayed with the estimated casualties by day based on the characterizations provided.

Once the user submits the characterization to the processor, the ROG interface 34 determines the appropriate key areas of concern and associated options that should be reviewed. These are presented as major “response” topic areas such as “Resource and Logistical Support” and “Criminal Investigation”, and options such as “Establish Reception Center for Support Personnel”. For most options there is additional information explaining how to carry out the option.

The ROG interface 34 gives the user the option to deselect any general topic areas that do not need to be pursued, as well as deselecting specific options in a topic area.

Based on the user selections, THI profile, and other characterizations, the ROG interface 34 calculates a time-phased resource list which outlines the resources required each day the event is expected to last. In the example of a biological attack, the list shows the number of specialists such as epidemiologists, medical clerks, paramedics, physicians, and security personnel that are required to handle the projected workload each day. In addition, the ROG interface 34 projects the quantities of equipment and consumable supplies such as HEPA masks, gloves, cots, and meals required by day.

The ROG interface 34 is also used to automatically access the RAMS schedules and personnel and equipment databases to determine what resources are available to meet the requirements expressed in the time-phased resource list. In the stand-alone version of the ROG interface 34, which does not have access to the RAMS databases, a spreadsheet is provided with a place to enter the resources available to determine the shortfalls.

The RAMS databases manage the status of the shortfalls, providing resource needs for neighboring principalities and/or local, state and federal government entities. If the other agencies are also using RAMS, communication is established electronically to communicate the available supplies from that agency using the messenger. For agencies without RAMS 14, alternative interfaces are available so agencies can provide inputs which automatically update the shortfall information in the ROG interface 34.

As options under the key topic areas are completed in the ensuing days, the ROG interface 34 is used to record the date and time that the item was completed. Once the contingency is complete, the ROG interface 34 archives the operation for future review and use.

During a minor contingency, it may not be useful to employ all of the functions of the ROG interface 34. For purposes of using the ROG interface 34, a minor contingency is a contingency that lasts for a few hours to one or two days and can be handled with available resources. For such contingencies, the ROG interface 34 provides a series of automated checklists to assist personnel in completing all the required actions. Once the contingency is determined as being minor, the user identifies the type of contingency, as when the contingency is a major contingency as described above.

The electronic checklists provide a sequenced list of actions to be accomplished. Each action has amplifying details to explain more how the action should be accomplished. When the user completes an action, it is checked off, automatically recording the date and time the action was completed. In addition, the ROG interface 34 provides a comments area for each checklist item in which additional information about the specific item is entered.

The ROG interface 34 allows selective viewing by other agencies as to the status of the checklist. The checklist can be shared with a remote location within the responding agency, or with other selected agencies as desired. This sharing capability allows the headquarters at a remote location and others to track the progress in handling the event. As each item is completed or comments updated, they are available for sharing.

Once the contingency is complete, the ROG interface 34 archives the operation for future review.

The operations manager interface 36 is used by a remote headquarters such as at a police headquarters, or City Emergency Management office, to monitor an on-going operation. Similar to the situational awareness interface 32, the operations manager interface provides additional functions to manage the information about an operation. The operations manager interface 36 provides a means to create a record for an operation, the record including information such as where the event occurred, when the event occurred, what the event was, and the like.

The user has the capability to drag and drop one or more location as required from the situation awareness interface 32 into a selected operation, and associates that location with the operation. Intelligence and operational information about the incident is stored with the operation, the information being in any digital format such as a word processing document, an image, or a video.

Of the resources tracked by the operations manager interface 36 there is included a shelter monitor, which tracks locations used as shelters, including the capacities and current occupancies of various available shelters. In the event the incident is a prolonged or planned event wherein workers are scheduled to participate, the operations manager interface includes scheduling capability.

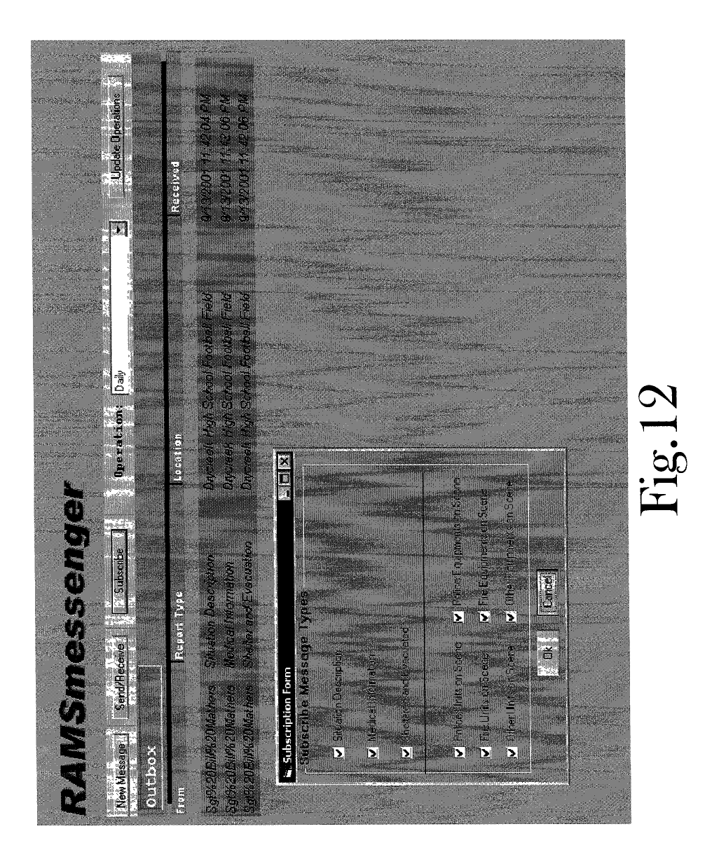

The messenger interface 38, illustrated in FIG. 12, is a pre-formatted, topic oriented messaging system. The messenger interface 38 supports both informational messages and messages that automatically update system data and displays. The messenger interface integrates with the ROG interface 34 for ongoing operations and supports message types update data in other parts of the system.

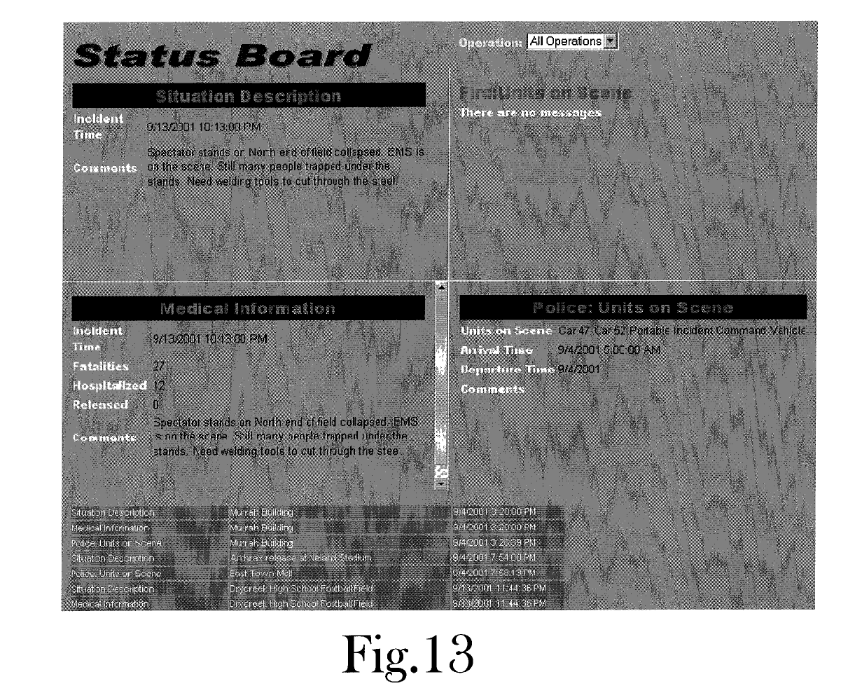

The status board interface 40, illustrated in FIG. 13 is a user configurable, menu driven situation display of key situational awareness data. The status board interface 40 automatically updates as information is changed in the system. Status information from a plurality of information areas is monitored via the status board interface 40. The screen automatically configures itself to display the requested information. As information sources change, the display automatically updates. The user defines the status data he/she wishes to monitor in the system and that status data is displayed and updated.

The planning module 22 assists users in planning for critical events. Included are a ROG creator 42, a situational awareness interface creator 44, a traffic manager creator 46, and an information tree creator 48.

The ROG creator 42 provides the user the ability to customize the underlying ROG checklists and automated response sub-modules for a specific city or organization. The ROG creator 42 also provides the ability to create new checklists and modify response templates.

The situational awareness interface creator 44 allows the user to create base data in the situational awareness interface 32. Information is added to the base data using standard techniques such as by dragging and dropping an icon representing that data into a specified location. This interface has been engineered so that the most intuitive method of accomplishing something is supported. As organization of the information in spatial relationships is a key method, this interface provides a multiplicity of manners in which information can be rapidly and easily added to the system. This allows crisis response professionals to be used to design the information rather than having to use a computer professional to accomplish the task.

The traffic manager creator 46 is used to develop traffic management plans as input by the user. Plans are executed and viewed in the operations manager interface. Traffic restrictions appear on the operations manager interface based on a real-time clock. For example, for planned road closings, roads are closed and opened on the map at the scheduled times. To this extent, the traffic manager creator 46 supports closed roads, one way roads, location of barricades, location of officers, and key routes such as those of dignitaries, parades, and evacuation routes.

The information tree creator 48 is used to design information categories and input documents to be viewed by the information tree. The user categorizes information in any number of categories and subcategories. Each of these categories and sub-categories, and particular data within each, is cross-referenced as required. As documents are added, they are copied into a RAMS-managed directory and renamed to an internal name in order to ensure that no document will overwrite any other document.

From the foregoing description, it will be recognized by those skilled in the art that a method for collecting, organizing, presenting and, utilizing information specific to a particular facility in order to provide a virtual walk-through of the facility has been provided. The virtual walk-through and associated information enables emergency response teams to quickly access critical information for the facility to effectively handle emergency situations including natural disasters or illegal activity. The method of the present invention can be performed by using stand-alone hardware having resident memory in which is stored the virtual walk-through, thereby allowing the on-site emergency response team immediate access to such data. Further, the virtual walk-through is capable of being contemporaneously updated to account for changes at the site during the course of the response. Additionally, it will be recognized by those skilled in the art that the method also provides an automated response and resource estimates to decision-makers in developing a response to significant unplanned emergency events. A powerful feature of this embodiment is its ability to forecast resources needed to respond to a disaster or crisis. This feature is beneficial in allowing the decision-makers to know well in advance what type of resources will need to be requested from neighboring cities, the county or State to handle any emergency situation, allowing them for the first time to be pro-active rather than reactive in a crisis situation.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. For example, the RAMS system may be encrypted to ensure that sensitive data and information included in its data collection would not be available to unauthorized individuals. The invention in its broader aspects is therefore not limited to the specific details, representative apparatus and methods, and illustrative examples shown and described. Accordingly, departures may be made from such details without departing from the spirit or scope of applicants' general inventive concept.

Having thus described the aforementioned invention, We claim:

1. A method for collecting, organizing, presenting and utilizing data relative to a disaster or terrorist action site for use by an emergency response team in responding at the site, said method comprising the steps of:
a)collecting data relative to a facility including at least one of a photograph, a spherical image, a site plan, a floor plan, chemical storage data, and fire equipment location information;
b) storing said data in memory on a computer, said data being organized in a both a hierarchy and across spatial diagrams;
c) inputting data relative to an emergency situation located at an emergency site;
d) selecting data within said hierarchy and said spatial diagrams necessary to assess said emergency situation;
e) preparing a response to the emergency situation;
f) responding to the emergency situation in a manner consistent with said step of preparing a response; and
g) updating said data as the emergency situation continues.

2. The method of claim 1 wherein said step of collecting data through said step of updating data is performed using a computer, and wherein a responder assets management system is resident within said memory.

3. The method of claim 2 wherein said responder assets management system includes at least one of an information module, a logistics module, an operations module, and a planning module.

4. The method of claim 3 wherein said information module includes a link to at least one of a local weather information source, a national weather information source, and said data stored in said memory, wherein said step of selecting data is performed by choosing a selected said link.

5. The method of claim 4 wherein said link to said data accesses an information tree and wherein said step of selecting data is performed by scrolling through said information tree to find selected of said data.

6. The method of claim 3 wherein said logistics module assists in managing equipment resources during an emergency response, said logistics module managing equipment information including at least one of title, location, date and time of use, and date and time of return, wherein said step of preparing a response includes the step of determining availability of equipment for use in responding.

7. The method of claim 3 wherein said operations module includes a plurality of interfaces including at least one of a situational awareness interface, an operations manager interface, a messenger interface and a status board interface, said step of responding to the emergency situation including the step of accessing at least one of said plurality of interfaces.

8. The method of claim 7 wherein said situational awareness interface is provided for a virtual walk-through, pre-incident planning, contingency planning, training visualization, and operational support using said data stored in said memory, said step of accessing at least one of said plurality of interfaces including the step of reviewing said data using said situational awareness interface.

9. The method of claim 8 wherein said step of accessing at least one of said plurality of interfaces further includes the step of annotating said data with information specific to the emergency situation including at least one of a description of extent of damage, and location of equipment and personnel.

10. The method of claim 9 wherein said step of accessing at least one of said plurality of interfaces further includes the step of transmitting said data for review at a remote location.

11. The method of claim 8 wherein said data includes at least one of a floor plan, a site plan and a map, wherein at least one icon representing localized information is indicated on said data to indicate location of a particular item, said step of reviewing said data further including the step of selecting said at least one icon to reveal said localized information.

12. The method of claim 8 wherein said situational awareness interface includes an incident layer in which information specific to a particular emergency situation is stored, wherein said step of reviewing said data further includes the step of reviewing said information specific to the particular emergency situation.

13. The method of claim 7 wherein said operations manager interface is provided for remotely monitoring progress during the emergency situation, said step of responding to the emergency situation including the step of creating a record of said response to the emergency situation including at least the time the emergency situation occurred, and the nature of the emergency situation.

14. The method of claim 7 wherein said messenger interface is provided to support informational messages and data update messages.

15. The method of claim 7 wherein said status board interface is provided for automatically updating said operations module, said step of responding to the emergency situation including the step of monitoring said data during said response to the emergency situation.

16. A method for providing automated response relative to significant unplanned emergency situation, said method comprising the steps of:
a) collecting data relative to an emergency situation;
b) identifying at least one type of an emergency situation;
c) inputting data relative to the known characteristics of said emergency situation;
d) generating a response to said emergency situation: and
e) tracking progress of said response to said emergency situation.

17. The method of claim 16 wherein said steps of collecting data through said step of tracking the progress of said response is performed using a computer and wherein a Responder Assets Management System is resident within said memory.

18. The method of claim 17 wherein said Responder Assets Management System includes at least one of an information module, a logistics module, an operations module, and a planning module.

19. The method of claim 18 wherein said operations module includes a response options generator interface.

20. The method of claim 19 wherein said response options generator interface is provided for automated response, said response options generator including at least one automated checklist of at least one action to be completed for preparing a response to the emergency situation, wherein said step of responding to the emergency situation includes the step of following said at least one checklist throughout the duration of said response to the emergency situation.

21. The method of claim 20 wherein said step of responding to the emergency further includes the step of capturing by said checklist a date and time of completion of said at least one action.

22. The method of claim 19 wherein said step of responding to the emergency further includes the step of generating a response using said resource generator interface, said response comprising a list of at least one option to be considered as an appropriate response to said emergency situation.

23. The method of claim 22 wherein said at least one option is selectively includable and excludable.

24. The method of claim 23 wherein said step of responding to the emergency further includes the step of tracking a selected response to include date and time of initiation of each response and time to complete.

25. The method of claim 23 wherein said selected response to the emergency situation further includes the step of generating a time-phased list of required resources using said response options generator, said resources in said time-phased list including at least one of personnel and supplies required at any interval during said response.
